(19) United States
(12) Patent Application Publication
(10) Pub. No.: US 2016/0328307 A1
(43) Pub. Date: Nov. 10, 2016

(54) RESOURCE MONITORING SYSTEM AND METHOD THEREOF

(71) Applicant: Quanta Computer Inc., Taoyuan City (TW)

(72) Inventors: Tsai-Hsing LU, Taoyuan City (TW); Chun-Hung CHEN, Taoyuan City (TW); Chien-Kuo HUNG, Taoyuan City (TW); Wen-Kuang CHEN, Taoyuan City (TW); Tien-Chin FANG, Taoyuan City (TW); Chen-Chung LEE, Nantou County (TW)

(73) Assignee: QUANTA COMPUTER INC., Taoyuan City (TW)

(21) Appl. No.: 14/813,951

(22) Filed: Jul. 30, 2015

(30) Foreign Application Priority Data
May 8, 2015 (TW) 104114771

(51) Int. Cl. G06F 11/30; G06F 17/30

(52) U.S. Cl. CPC G06F 11/3051; G06F 17/3051

(57) ABSTRACT

The invention provides a resource monitoring system. The monitoring unit inputs the collected monitoring data to a data-monitoring queue. The monitoring data stored in data-monitoring queue is inputted into a database. A trigger event is created when the monitor data satisfies the corresponding triggering conditions. In addition, an disposal mechanism is processed according to the triggering event. As such, the system can reply the trigger event at time.

### RELATED APPLICATIONS

This application claims priority to Taiwanese Application Serial Number 104114771, filed May 8, 2015, which is herein incorporated by reference.

### BACKGROUND

1. Field of Disclosure

The present disclosure relates to a resource monitoring system. More particularly, the present disclosure relates to a resource monitoring system for integrating many kinds of monitoring software.

2. Description of Related Art

So far, many monitoring softwares are on the market. Most of these monitoring softwares having considerable monitoring functions. There are specialized companies for providing the products for monitoring the software or hardware, monitoring the user behavior or monitoring the data flow. An aspect of the monitoring items, the single monitoring software only provides the limited monitoring items. However, it needs many kinds of monitoring software to meet the practical requirements in the common use scenarios. At the moment, only buying the new monitoring software, asking the monitoring software developer to provide support or developing by itself may solve this problem. No matter what kind of method above mentioned to use for reaching the goal of monitoring, the integration between different software becomes a difficult problem. If a completed solution is not provided, it may need to face on the problem of efficiency after finishing integration. Thus, the problems above-mentioned need to be overcome one by one.

On another hand, the common disposition of monitoring software is to provide reports, suggestions, displaying data on dashboard, limiting operation behavior, or notifying the administrator after monitoring is finished. The disposition is depending on the function providing by the monitoring software. The disposition cannot be expanded or shared. Thus, the system cannot automatically execute even the internal of an enterprise having a nice standard operation processing. As such, when the monitoring software detects abnormal events, the monitoring software cannot provide the corresponding solution to remove the abnormal situation. The monitoring software only can notice the administrator. The administrator still needs to further manually remove the abnormal situation. It not only causes the heavy loading of the administrator but also cannot remove the abnormal event immediately.

### SUMMARY

For solving the problem of related art, the present invention provides a resource monitoring system. The resource monitoring system can be applied for multi-functional monitoring agent mechanism. The resource monitoring system may include amount of monitoring items by using different monitoring software, and the same monitoring items also can be monitored by different monitoring software in the same time. The resource monitoring system can selectively cooperate the automation to perform the disposition operation for adding the monitoring precision and achieving the effect of monitoring integration.

An aspect of the present invention is to provide a resource monitoring system to solve the problems above described. The resource monitoring system includes a database, a resource monitoring module and a disposal mechanism module. The resource monitoring module includes a plurality of monitoring units, a collecting monitoring data module and an event triggering monitoring module. The monitoring units uses for detecting a plurality of monitoring data, and the monitoring data are different to each other. The collecting monitoring data module uses for collecting the monitoring data and sequentially inputting the monitoring data into a data-monitoring queue, wherein the monitoring data in the data-monitoring queue are stored in the database. The event triggering monitoring module uses for obtaining a plurality of triggering conditions and accessing the monitoring data from the database, each triggering condition corresponding to the one of the monitoring data, wherein the event triggering monitoring module uses for comparing at least two monitoring data respectively with the corresponding at least two triggering conditions, and the at least two monitoring data are in a group, if the group of the at least two monitoring data is satisfied with the corresponding at least two triggering conditions, the event triggering monitoring module establishes a triggering event according to the at least two monitoring data and inputs the triggering event into a task-scheduling queue. The disposal mechanism module uses for processing a disposal operation corresponding to each triggering event stored in the task-scheduling queue.

According to another embodiment of the present disclosure, wherein after processing the disposal operation corresponding to the triggering event, the event triggering monitoring module further uses for unregistering the related triggering events and then registering the related triggering events again after a cool down time.

According to another embodiment of the present disclosure, wherein the resource monitoring module further comprises: an event and monitoring target bounding module for bounding a monitoring target to the triggering event.

According to another embodiment of the present disclosure, wherein the resource monitoring module further comprises: an triggering condition defining module for configuring the triggering event.

According to another embodiment of the present disclosure, wherein the disposal mechanism module further comprises: a regulation and event bounding module for determining whether the triggering event conflicts with the disposal operation; if the triggering event does not conflict with the disposal operation, bounding the triggering event and the disposal operation.

According to another embodiment of the present disclosure, further including: a disposal operation defining module uses for obtaining at least candidate operation currently supported, and determining whether the at least candidate operation is suitable for the current triggering event, if the at least candidate operation is suitable for the current triggering event, the suitable candidate operations is arranged as a operation order, and the disposal operation is composed by the suitable candidate operations of the operation order.

According to another embodiment of the present disclosure, wherein the collecting monitoring data module further uses for collecting the monitoring data at regular intervals, and sequentially inputting the monitoring data into the data-monitoring queue; and then storing the monitoring data of the data-monitoring queue into the database enabled by a triggering operation after a period of time.

Another aspect of the present invention is to provide a resource monitoring method to solve the problems above described. The resource monitoring method includes following steps: detecting a plurality of different monitoring data, and the monitoring data are different to each other; collecting the monitoring data and sequentially inputting the monitoring data into a data-monitoring queue, wherein the monitoring data in the data-monitoring queue are stored in the database; obtaining a plurality of triggering conditions and accessing the monitoring data from the database, each triggering condition corresponding to the one of the monitoring data, comparing at least two monitoring data respectively with the corresponding at least two triggering conditions, and the at least two monitoring data are in a group, if the group of the at least two monitoring data is satisfied with the corresponding at least two triggering conditions, the a triggering event is established according to the at least two monitoring data and the triggering event is inputted into a task-scheduling queue; processing a disposal operation corresponding to each triggering event stored in the task-scheduling queue.

According to another embodiment of the present disclosure, wherein after the step of processing the disposal operation corresponding to each triggering event stored in the task-scheduling queue, further including: unregistering the related triggering events and then registering the related triggering events again after a cool down time.

According to another embodiment of the present disclosure, further including: bounding a monitoring target to the triggering by an event and monitoring target bounding module.

According to another embodiment of the present disclosure, further including: configuring the triggering event by a triggering condition defining module.

According to another embodiment of the present disclosure, further including: determining whether the triggering event conflicts with the disposal operation by a regulation and event bounding module; if the triggering event does not conflict with the disposal operation, bounding the triggering event and the disposal operation.

According to another embodiment of the present disclosure, further including: obtaining at least candidate operation currently supported, and determining whether the at least candidate operation is suitable for the current triggering event, if the at least candidate operation is suitable for the current triggering event, the suitable candidate operations is arranged as a operation order, and the disposal operation is composed by the suitable candidate operations of the operation order.

According to another embodiment of the present disclosure, further including: collecting the monitoring data at regular intervals, and sequentially inputting the monitoring data into the data-monitoring queue; and then storing the monitoring data of the data-monitoring queue into the database enabled by a triggering operation after a period of time.

Base on above-mentioned, the resource monitoring system of present invention solves the deficiency of related art, which is hard to integrate different monitoring software. The resource monitoring system of the present disclosure provides a complete solution, which is suitable to apply for the multi-functional agent mechanism. When updating or adding the monitoring software, the resource monitoring system does not need to spend a lot of time or human resource for the integration. And then, the resource monitoring system can achieve the effect of monitoring at the same time by different monitoring software.

### BRIEF DESCRIPTION OF THE DRAWINGS

FIG. 1 is a schematic diagram illustrating a resource monitoring system according to an embodiment of the disclosure.

FIG. 2 is a flow chart of a resource monitoring method according to an embodiment of the disclosure.

FIG. 3 is a flow chart of a triggering condition defining method according to an embodiment of the disclosure.

FIG. 4 is a flow chart of a triggering event and a monitoring target bonding method according to an embodiment of the disclosure.

FIG. 5 is a flow chart of a triggering event and a disposal operation bonding method according to an embodiment of the disclosure.

FIG. 6 is a flow chart of a disposal operation defining method according to an embodiment of the disclosure.

FIG. 7 is a flow chart of a unregistering and registering triggering condition method according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

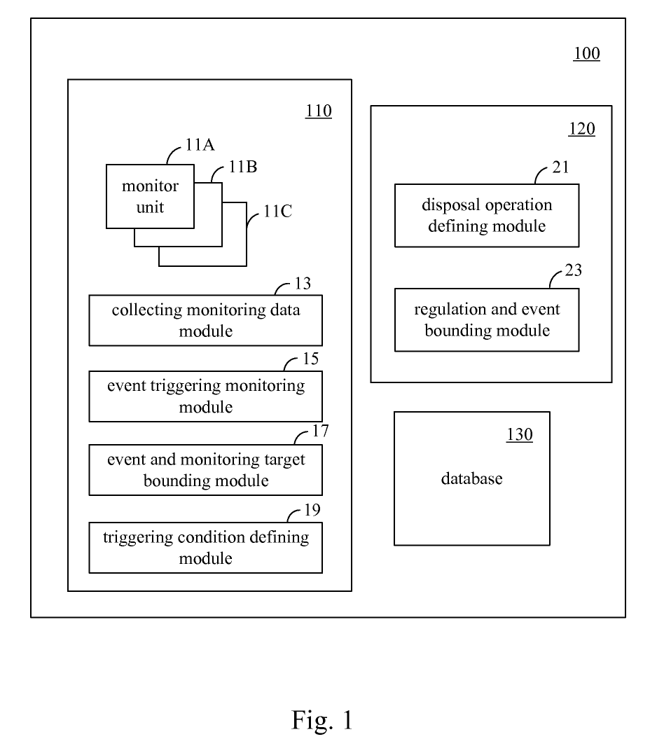

Referring to FIGS. 1, FIG. 1 is a schematic diagram illustrating a resource monitoring system according to an embodiment of the disclosure. As shown in FIG. 1, the resource monitoring system 100 includes a resource monitoring module 110, a disposal mechanism module 120 and a database 130. The resource monitoring module 110 includes a plurality of monitor units 11A-11C, a collecting monitoring data module 13 and an event triggering monitoring module 15. In an embodiment, the resource monitoring module 110 can further include an event and monitoring target bounding module 17 and a triggering condition defining module 19. In each embodiment of present application, the resource monitoring system 100 can be a personal computer, a server computer, a smart phone, a panel, or a smart TV. The resource monitoring module 110 and the disposal mechanism module 120 can be implemented by central processing unit (CPU), control unit, micro processor or other hardware unit which can execute instructions. The database 130 may be stored in non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. In an embodiment, the disposal mechanism module 120 further includes a disposal operation defining module 21 and a regulation and event bounding module 23.

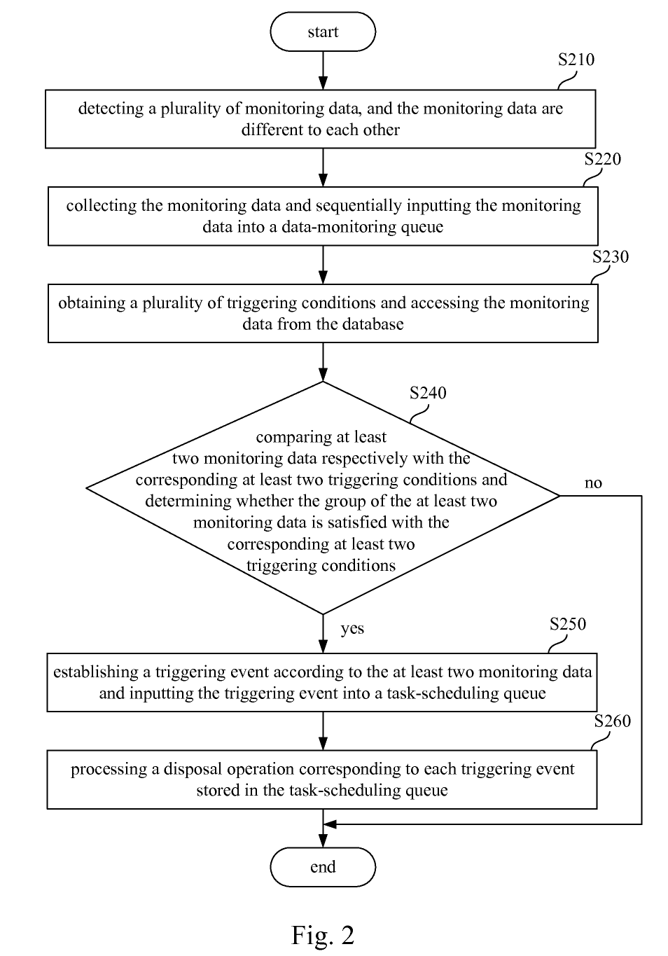

As shown in FIG. 2, FIG. 2 is a flow chart of a resource monitoring method according to an embodiment of the disclosure. The resource monitoring method 200 can be implemented as a product of computer program (e.g. application) and stored in a computer-readable medium. The computer can access the record of medium for executing the resource monitoring method 200. The aforementioned computer can be a processing unit of the resource monitoring system 100, and the processing unit includes a central process unit, a control unit, a microprocessor, or the equivalents. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

Referring to both of FIG. 1 and FIG. 2, for illustration, the operations of the resource monitoring system 100 in FIG. 1 are described by the resource monitoring method 200 with reference to FIG. 2.

In step S210, the monitor units 11A-11C detects a plurality of monitoring data, and the monitoring data are different to each other.

For example, the monitor unit 11A can be a temperature sensor for detecting the temperature of environment to obtain the environment monitoring data. The monitor unit 11B can be a power sensor for detecting the power of the device. The monitor unit 11C can be a memory usage sensor for detecting the memory usage of the device to obtain the memory usage monitoring data. In another embodiment, the resource monitoring system 100 can include but not limited thereto, one or more monitoring unit. Each of the monitoring units 11A-11C can further include many kinds of switch controller of module or circuit (e.g. water circulation module, wireless communication module, fan module).

In step S220, the collecting monitoring data module 13 collects the monitoring data from the monitoring units 11A-11C and sequentially inputting the monitoring data into a data-monitoring queue, wherein the monitoring data in the data-monitoring queue are stored in the database 130. In one embodiment, the monitoring data of the data-monitoring queue stores into the database 130 enabled by a triggering operation after a period of time.

The multi-functional agent mechanism usually uses in the system architecture. The system architecture needs maintaining in the high ability. The monitoring unit 11A-11C may quite frequently collect these monitoring data. The monitoring data can be considered as composing by data and data description. Thus, the monitoring data regards as a message and can be inputted into a data-monitoring queue. By the characteristic of first in first out of the data-monitoring queue, the message that is inputted firstly will be processed firstly. The other messages have not been processed may still store in the data-monitoring queue. In this manner, in the condition of frequently collecting data, the problem of data locked due to too many programs access one database at the same time can be avoided.

In another embodiment, the data-monitoring queue can trigger the function of itself to store the data into the specified table of the database 130. The method mentioned above can solve the data-exchanging problem between different platform and different application. It is helpful for the subsequent accessing data and applying data. Besides, the resource monitoring system 100 does not need to consider the protocol of communication when monitoring units 11A-11C obtain many kinds of monitoring data from different application software. The resource monitoring system 100 only needs to sequentially input the monitoring data as messages into the data-monitoring queue. Thus, the monitoring units 11A-11C can easily connect to the many kinds of monitoring software.

Next, in step S230, the event triggering monitoring module 15 obtains a plurality of triggering conditions and accessing the monitoring data from the database 130, each triggering condition corresponding to the one of the monitoring data.

For example, when a CPU usage of a server is over 80% and lasting the status over 10 minutes, this configuration means a triggering condition. The triggering condition can be added and modified in anytime. But, the triggering event cannot be deleted after the triggering condition bounding to an event. The bounding relationship needs to be cancelled firstly for deleting the triggering. A set of triggering condition settings not only includes monitoring items (e.g. CPU) but also includes operator, threshold (e.g. usage exceeds 80%) or lasting time (e.g. lasting 10 minutes). Thus, every triggering condition corresponding to at least one of the monitoring data. The meaning of lasting time settings is to avoid the event triggered too often. The configuration of triggering condition can be modified according to the user requirement experience or according to a record of a triggering event to find the optimized settings. In above-mentioned example, the CPU usage of a server is over 80% and lasting the status over 10 minutes which includes the set of monitoring items, thresholds and lasting time.

In one embodiment, the selected monitoring items can be modified according the items collected by collecting monitoring data module 13. The collecting monitoring data module 13 can be flexibly expended to collect more kinds of monitoring data.

In another embodiment, the triggering condition defining module 19 is used for setting these triggering conditions. The detailed triggering condition defining method is described hereinafter.

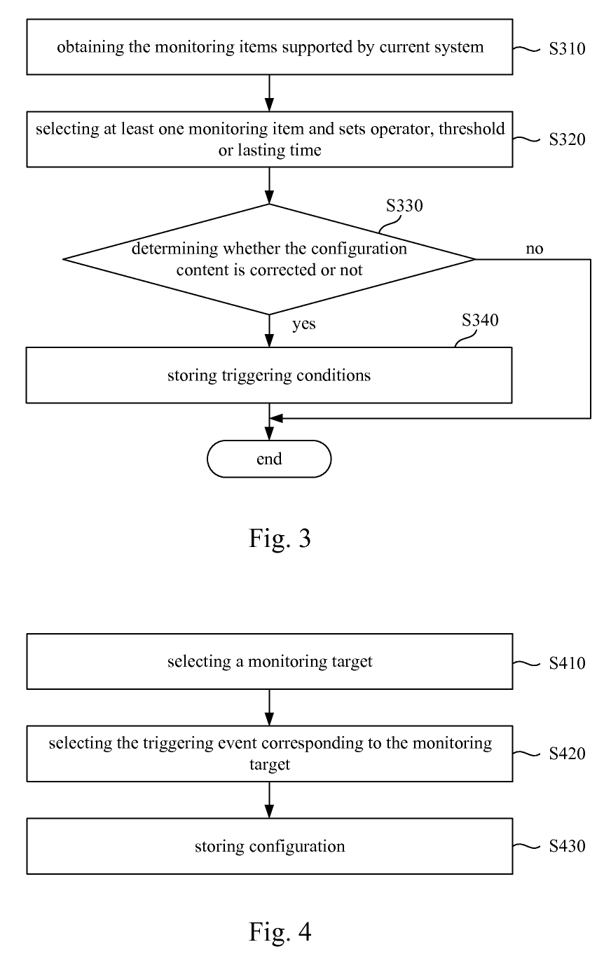

Referring to FIGS. 2 and 3, FIG. 3 is a flow chart of a triggering condition defining method according to an embodiment of the disclosure.

In step S310, a triggering condition defining module 19 obtains the monitoring items supported by current system. In one embodiment, the monitoring items can be the at least one to-be monitored items, such as CPU, memory, computer peripheral device, program.

In step S320, the triggering condition defining module 19 selects at least one monitoring item and sets operator, threshold or lasting time.

In step S330, the triggering condition defining module 19 determines whether the configuration content is corrected or not. For example, the threshold cannot be set as a negative number when setting the usage of monitoring CPU. If the triggering condition defining module 19 determines the configuration content is not corrected, the procedure ends. If the triggering condition defining module 19 determines the configuration content is corrected, the step S340 is performed.

In step S340, the triggering conditions are stored.

In this manner, triggering condition defining module 19 finishes a set of the configuration of triggering conditions to make the event triggering monitoring module 15 can obtain the triggering conditions and access the monitoring data from database 130.

Next, go back to the step S240 in FIG. 2. The event triggering monitoring module 15 compares at least two monitoring data respectively with the corresponding at least two triggering conditions and determines whether the group of the at least two monitoring data is satisfied with the corresponding at least two triggering conditions. In this embodiment, the resource monitoring system 100 can use for monitoring the plurality of monitoring data and the plurality of triggering conditions. Therefore, the event triggering monitoring module 15 compares the at least two monitoring data respectively with the corresponding at least two triggering conditions, and the at least two monitoring data are in a group. However, in another embodiment, the event triggering monitoring module 15 compares the one monitoring data respectively with the corresponding one triggering condition.

In step S250, if the group of the at least two monitoring data is satisfied with the corresponding at least two triggering conditions, the event triggering monitoring module 15 establishes a triggering event according to the at least two monitoring data and inputs the triggering event into a task-scheduling queue.

For example, in step S240, if a triggering condition is defined as the usage of CPU is higher than 80% and another triggering condition is as the usage of memory is higher than 85%, a triggering event is established. Next, if one of the collected monitoring data is 90% CPU usage and another one of the collected monitoring data is 90% memory usage, the event triggering monitoring module 15 compares the at least two monitoring data respectively with the corresponding at least two triggering conditions. And then, the event triggering monitoring module 15 determines the at least two monitoring data (90% CPU usage, 90% memory usage) is satisfied with the corresponding at least two triggering conditions (if CPU usage is higher than 80%, if memory usage is higher than 85%) and the step S250 is performed. That is, each triggering event may include at least one of the combinations of triggering events. For example, when the system temperature is higher than 70 degree centigrade, the fan speed is higher than 7000 rpm, and the water circulation module is not turning on, the water circulation module can be triggered. Or, when the power of device is lower than 20% and the to be processed procedure is higher than 95% of total loading, and the brightness of display is higher then 80% or the volume of loudspeaker is higher than 70%, the display can be triggered to decrease the brightness or the loudspeaker can be triggered to decrease the volume.

Next, in step S250, the event triggering monitoring module 15 establishes a triggering event according to the at least two monitoring data and inputs the triggering event into a task-scheduling queue.

In one embodiment, the monitoring data corresponding to the monitoring target is relative to the triggering event in step S240-S250. In this manner, the triggering event corresponding to the monitoring target is established after determining the monitoring data satisfied the corresponding triggering event. Thus, the monitoring data corresponding to the monitoring target needs to be bounded to these triggering conditions. In one embodiment, the event and monitoring target bounding module 17 is used for bounding the selected monitoring target to the triggering event. The detail of the method of bounding monitoring target to the triggering event is as below.

Referring to FIG. 4, FIG. 4 is a flow chart of a triggering event and a monitoring target bonding method according to an embodiment of the disclosure.

In step S410, the event and monitoring target bounding module 17 is used for selecting a monitoring target. For example, the event and monitoring target bounding module 17 previously selects the monitoring target as a virtual machine.

In step S420, the event and monitoring target bounding module 17 selects the triggering event corresponding to the monitoring target. Therefore, the automatic operation behavior of the system when the triggering event is triggered is configured. For example, the triggering event is defined as automatically turning off the virtual machine.

In step S430, the configuration is stored for finishing the bounding of triggering event and the triggering target.

In another embodiment, the triggering condition is relative to the triggering event in step S240-S250. The regulation and event bounding module 23 is used for bounding the triggering event and the triggering condition and the triggering event can be composed by a plurality of operation behavior and can be configured the order of each operation behavior.

For example, it means the server needs to be added for providing service when the combination of the monitoring data satisfies the corresponding triggering condition. The regulation and event bounding module 23 is used for determining the triggering condition and defining the triggering event as including the operation items of establishing virtual machines, automatically setting IP, automatically deploying programs, adding the configuration of load balance. In addition, the operation items can be added according to the different requirements. Thus, in step S250, the event triggering monitoring module 15 may inputs the triggering event into a task-scheduling queue. The triggering event can include a plurality of operation items. The event triggering monitoring module 15 subsequent triggers these operation items according to the order in the task-scheduling queue. Besides, a triggering event can be bounded to the plurality of triggering condition in this embodiment. Also, the triggering condition can be configured to trigger the triggering event when achieving all the triggering conditions or achieving at least one of the triggering conditions.

Next, go back to the step S260 in FIG. 2. The disposal mechanism module processes a disposal operation corresponding to each triggering event stored in the task-scheduling queue.

In the aforementioned example, if the disposal operation corresponding to the triggering event is to turn on the other three backup host server for load balance, the event triggering monitoring module 15 automatically turns on the other three backup host server or notifies user to turn on the other three backup host server by a notification signal. The triggering event is established by event triggering monitoring module 15.

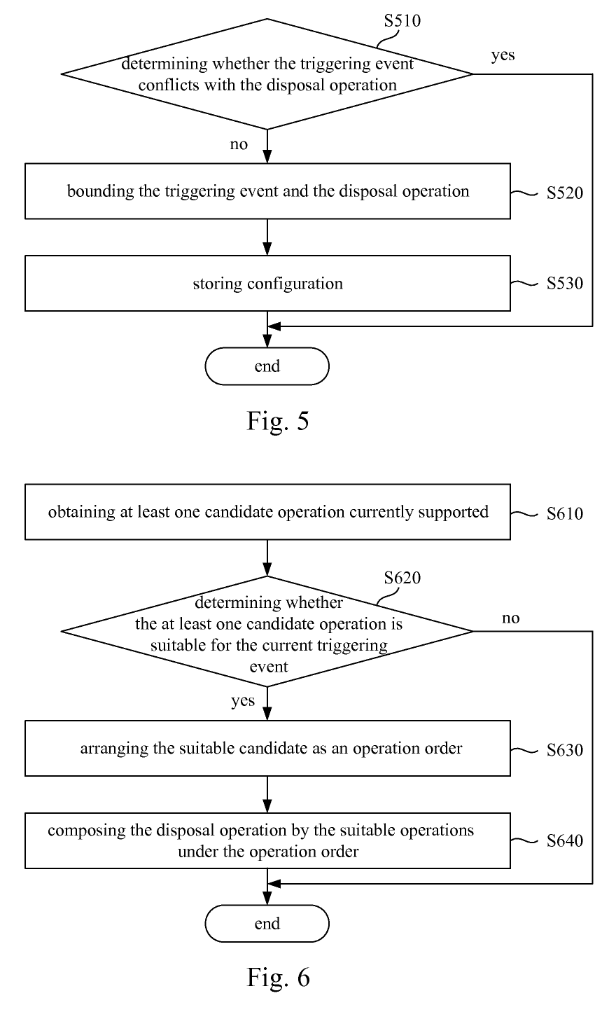

In one embodiment, the situation of whether the triggering event conflicts with the disposal operation is determined. Referring to FIG. 5, FIG. 5 is a flow chart of a triggering event and a disposal operation bonding method according to an embodiment of the disclosure.

In step S510, a regulation and event bounding module 23 determines whether the triggering event conflicts with the disposal operation. For example, the triggering event is configured to turn on 100 virtual machines. However, if the system determines the current environment cannot support the triggering event, the triggering event is determined as conflicting with the disposal operation. On the contrary, the step S520 is performed if the triggering event is not determined as conflicting with the disposal operation.

In step S520, the regulation and event bounding module 23 bounds the triggering event and the disposal operation.

For instance, a triggering event is satisfied when a CPU usage of a server achieves 90% and lasts 10 minutes. The triggering event can be configured to turn off some unimportant or specified background applications and turn on two servers to decrease the usage of the CPU. When the regulation and event bounding module 23 determines that the triggering event does not conflict with the disposal operation in step S510, the disposal operation corresponding to the triggering event can turn off some of unimportant or specified background applications and then turn on two servers for adding into the service group.

In step S530, the configurations are stored for preparing to process the disposal operation.

In another embodiment, the disposal operation can be defined corresponding to the current triggering event. The detail of the method of defining disposal operation is as below.

Referring to FIG. 6, FIG. 6 is a flow chart of a disposal operation defining method according to an embodiment of the disclosure.

In step S610, the disposal operation defining module 21 obtains at least one candidate operation currently supported. In one embodiment, the monitoring target can support at least one candidate operation, such as controlling the network flow, adjusting power, adjusting temperate, executing or closing the applications, turning on the virtual machine or turning on the another server, etc.

In step S620, the disposal operation defining module 21 determines whether the at least one candidate operation is suitable for the current triggering event. For example, the currently triggering event is configured as stopping uploading data, closing the specified application, turning on a virtual machine and turning on two servers, and the candidate operation is stopping uploading data, closing the specified application, turning on a virtual machine and turning on two servers. Next, the disposal operation defining module 21 determines whether the at least one candidate operation is suitable for the current triggering event. For example, if the disposal operation defining module 21 determines that the current environment does not have another two servers, only stopping uploading data, closing the specified application, turning on a virtual machine these three candidate operations are suitable for the current triggering event.

In step S630, the suitable candidate operations are arranged as an operation order. For instance, the suitable candidate operations are arranged as stopping uploading data firstly, turning on a virtual machine secondly and then closing the specified application.

In step S640, the disposal operation is composed by the suitable candidate operations under the operation order. For example, the disposal operation defining module 21 regards stopping uploading data firstly, turning on a virtual machine secondly and then closing the specified application as a disposal operation.

Therefore, the system can achieve the effect of automatically performing a serial of operation event when executing the disposal operation.

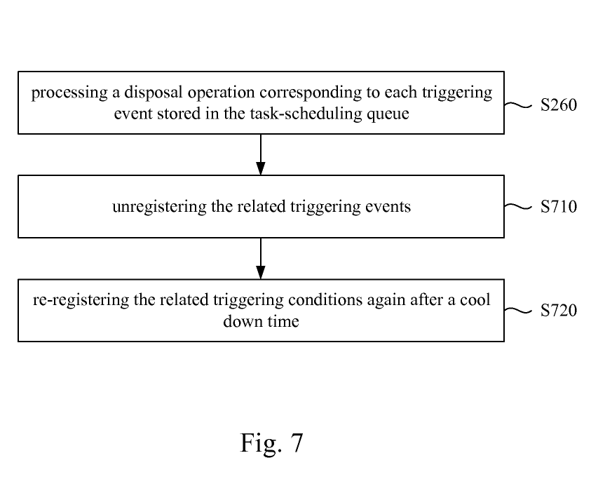

In one embodiment, after the step S260 the event triggering monitoring module 15 performing the disposal operation corresponding to the triggering event, the event triggering monitoring module 15 can further use for unregistering the related triggering conditions and then re-registering the related triggering conditions again. Referring to FIG. 7, FIG. 7 is a flow chart of a unregistering and registering triggering condition method according to an embodiment of the disclosure.

In step S710, the event triggering monitoring module 15 uses for unregistering the related triggering events.

In step S720, the event triggering monitoring module 15 uses for re-registering the related triggering conditions again after a cool down time.

For example, the collected monitoring data can be configured as messages for storing in the data-monitoring queue. The event triggering monitoring module 15 sequentially checks whether the monitoring data satisfies the triggering event or not from the data-monitoring queue. If the monitoring data does not satisfy the triggering event, the message corresponding to the monitoring data is abandoned directly. In contrast, when the event triggering monitoring module 15 confirms that the monitoring data satisfies the triggering event, the event triggering monitoring module 15 stores the information into the task-scheduling queue. The task-scheduling queue invokes every application system to execute the disposal operation corresponding to the triggering event. After the disposal operation is triggered, the related triggering events are unregistered. After a cool down time, the related triggering conditions are automatically re-registered again. For example, in a condition of the turning on the five virtual machines, it needs at least two minutes of cool down time for turning on next virtual machine. Thus, after turning on each virtual machine, the related triggering conditions are automatically unregistered firstly, and then the related triggering conditions are automatically re-registered again after a cool down time. In this way, the busy system causes by continually invoking the next virtual machine during turning on the first virtual machine can be avoided. The event triggering monitoring module 15 can repeat the actions above mentioned regularly to achieve the effect of continuously monitoring the condition health of the whole environment.

Based on above, the present disclosure provides a resource monitoring system and method thereof. The resource monitoring system and method can integrate the different kinds of monitoring data collected by monitoring unit and monitor the huge amount of monitoring data. The resource monitoring system and method also can compare many kinds of monitoring data with many kinds of triggering condition for determining whether to establish a corresponding triggering event and perform the corresponding disposal operation according to the triggering event. Thus, the method and the system can automatically monitor every target, which can be monitored. The method and the system can follow the configured standard operation procedure to automatically perform the suitable disposal operation when the configured standard is achieved. This can avoid delaying the processing time. The method and the system can also achieve the effect of decreasing the working loading of administrator, adding the flexibility of monitoring system, and achieving the monitoring integration.

Although the present disclosure has been described in considerable detail with reference to certain embodiments thereof, other embodiments are possible. Therefore, the spirit and scope of the appended claims should not be limited to the description of the embodiments contained herein.

What is claimed is:

1. A resource monitoring system, comprising:
a database;
a resource monitoring module, comprising:
a plurality of monitoring units for detecting a plurality of monitoring data, and the monitoring data are different to each other;
a collecting monitoring data module for collecting the monitoring data and sequentially inputting the monitoring data into a data-monitoring queue, wherein the monitoring data in the data-monitoring queue are stored in the database; and
an event triggering monitoring module for obtaining a plurality of triggering conditions and accessing the monitoring data from the database, each triggering condition corresponding to the one of the monitoring data, wherein the event triggering monitoring module uses for comparing at least two monitoring data respectively with the corresponding at least two triggering conditions, and the at least two monitoring data are in a group, if the group of the at least two monitoring data is satisfied with the corresponding at least two triggering conditions, the event triggering monitoring module establishes a triggering event according to the at least two monitoring data and inputs the triggering event into a task-scheduling queue;
a disposal mechanism module for processing a disposal operation corresponding to each triggering event stored in the task-scheduling queue.

2. The resource monitoring system of claim 1, wherein after processing the disposal operation corresponding to the triggering event, the event triggering monitoring module further uses for unregistering the related triggering conditions and then re-registering the related triggering conditions again after a cool down time.

3. The resource monitoring system of claim 1, wherein the resource monitoring module further comprises:
an event and monitoring target bounding module for bounding a monitoring target to the triggering event.

4. The resource monitoring system of claim 1, wherein the resource monitoring module further comprises:
a triggering condition defining module for configuring the triggering event.

5. The resource monitoring system of claim 1, wherein the disposal mechanism module further comprises:
a regulation and event bounding module for determining whether the triggering event conflicts with the disposal operation; if the triggering event does not conflict with the disposal operation, bounding the triggering event and the disposal operation.

6. The resource monitoring system of claim 1, further comprising:
a disposal operation defining module for obtaining at least one candidate operation currently supported, and determining whether the at least one candidate operation is suitable for the current triggering event, if the at least candidate one operation is suitable for the current triggering event, the suitable candidate operations are arranged as an operation order, and the disposal operation is composed by the suitable candidate operations under the operation order.

7. The resource monitoring system of claim 1, wherein the collecting monitoring data module further uses for collecting the monitoring data at regular intervals, and sequentially inputting the monitoring data into the data-monitoring queue; and then storing the monitoring data of the data-monitoring queue into the database enabled by a triggering operation after a period of time.

8. The resource monitoring method, comprising:
detecting a plurality of different monitoring data, and the monitoring data are different to each other;
collecting the monitoring data and sequentially inputting the monitoring data into a data-monitoring queue, wherein the monitoring data in the data-monitoring queue are stored in the database;
obtaining a plurality of triggering conditions and accessing the monitoring data from the database, each triggering condition corresponding to the one of the monitoring data, comparing at least two monitoring data respectively with the corresponding at least two triggering conditions, and the at least two monitoring data are in a group, if the group of the at least two monitoring data is satisfied with the corresponding at least two triggering conditions, the a triggering event is established according to the at least two monitoring data and the triggering event is inputted into a task-scheduling queue;
processing a disposal operation corresponding to each triggering event stored in the task-scheduling queue.

9. The resource monitoring method of claim 8, wherein after the step of processing the disposal operation corresponding to each triggering event stored in the task-scheduling queue, further comprising:
unregistering the related triggering conditions and then re-registering the related triggering conditions again after a cool down time.

10. The resource monitoring method of claim 8, further comprising:
bounding a monitoring target to the triggering by an event and monitoring target bounding module.
